(19) United States
(12) Patent Application Publication
(10) Pub. No.: US 2014/0102493 A1
(43) Pub. Date: Apr. 17, 2014

(54) ULTRASONIC CLEANING APPARATUS

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/707,575

(22) Filed: Dec. 6, 2012

(30) Foreign Application Priority Data
Oct. 15, 2012 (TW) 101137983

(51) Int. Cl. B08B 3/12

(52) U.S. Cl. CPC B08B 3/12
USPC 134/184

(57) ABSTRACT

An ultrasonic cleaning apparatus includes a cleaning tank, a control device and a plurality of ultrasonic transducers. The cleaning tank includes a bottom surface. The ultrasonic transducers are located in the cleaning tank and are inclined relative to the bottom surface so that ultrasonic waves from the ultrasonic transducers concentrate in a same region within the cleaning tank. The control device is located outside of the cleaning tank and electrically connected with the ultrasonic transducers. The control device controls the ultrasonic transducers to emit out the ultrasonic waves.

### BACKGROUND

1. Technical Field

The present disclosure relates to an ultrasonic cleaning apparatus.

2. Description of Related Art

An ultrasonic cleaning apparatus is used for cleaning contamination, such as adhesive, on precision parts. The ultrasonic cleaning apparatus generally includes a cleaning tank and a number of ultrasonic transducers. However, the ultrasonic transducers are arranged on the bottom of the cleaning tank in parallel, and waves emitted from the ultrasonic transducer are dispersed in the entire cleaning tank evenly, and therefore, the cleaning efficiency of the ultrasonic cleaning apparatus is low.

Therefore, it is desirable to provide an ultrasonic cleaning apparatus that can overcome or at least alleviate the above-mentioned limitations.

### BRIEF DESCRIPTION OF THE DRAWINGS

FIG. 1 is a schematic view of an ultrasonic cleaning apparatus according to an exemplary embodiment.

FIG. 2 is a schematic view of the ultrasonic cleaning apparatus of FIG. 1 in a working state.

### DETAILED DESCRIPTION

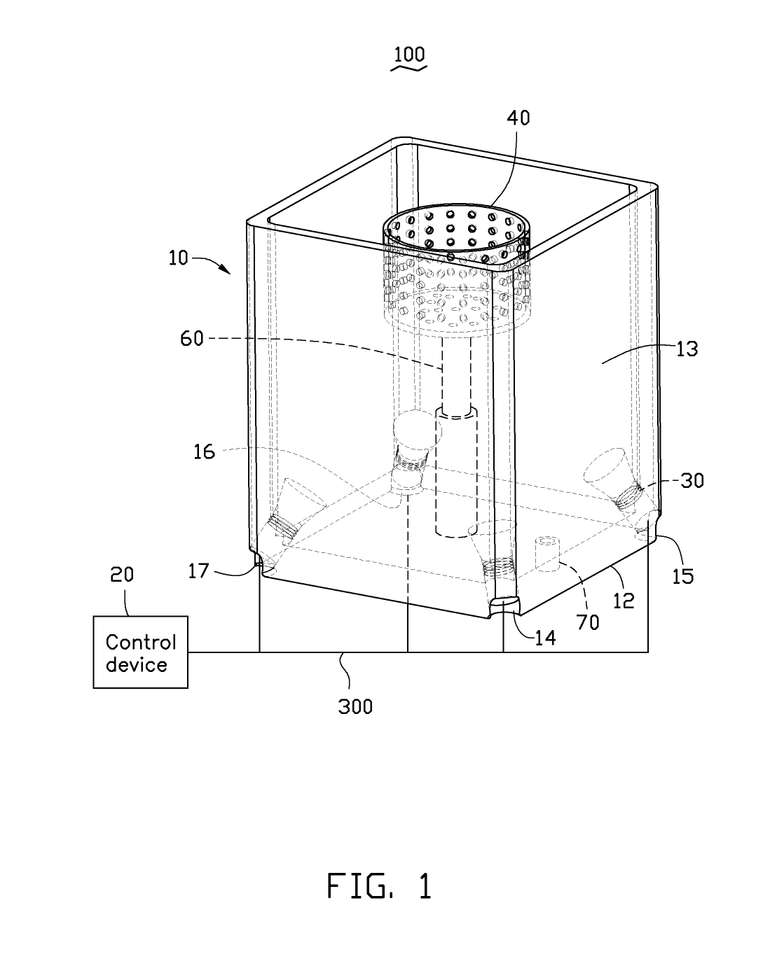

FIG. 1 shows an ultrasonic cleaning apparatus 100 according to an exemplary embodiment. The ultrasonic cleaning apparatus 100 includes a cleaning tank 10, a control device 20, four ultrasonic transducers 30 and a porous container 40.

The cleaning tank 10 is substantially parallelepiped shaped and is used for holding cleaning liquid. The upper end of the cleaning tank 10 is an opened end, so the cleaning liquid can be easily injected into the cleaning tank 10 from the upper end 102.

The cleaning tank 10 includes a bottom surface 12 and four side surfaces 13 The four side surfaces 13 are sequentially connected. The cleaning tank 10 further includes four corners 14, 15, 16 and 17. Each corner is formed by joint of each two adjacent side surfaces 13 and the bottom surface 12. The corner 14 and the corner 16 are located at one diagonal line of the bottom surface 12, and the corner 15 and the corner 17 are located at the other diagonal line of the bottom surface 12.

Each ultrasonic transducer 30 is arranged at each of the corners 14, 15, 16 and 17. The four ultrasonic transducers 30 are arranged obliquely with respective to the bottom surface 12, and an included angle between each of the ultrasonic transducers 30 and the bottom surface 12 is equal to each other so that ultrasonic waves emitted from the four ultrasonic transducers 30 can concentrate at a same predetermined area in the cleaning tank 10. In other embodiments, the ultrasonic cleaning apparatus 100 may include two ultrasonic transducers 30. The two ultrasonic transducers 30 are located on a diagonal line of the bottom surface 12.

There is no specific requirement about the included angle between each ultrasonic transducer 30 and the bottom surface 12, there only needs to be an area inside the cleaning tank 10 where the ultrasonic waves emitted from the ultrasonic transducers 30 are concentrated. The bottom surface 12 of the cleaning tank 10 also includes a drain valve 70. After cleaning, the liquid can be discharged from the drain valve 70.

The porous container 40 is used for holding workpieces to be cleaned. The porous container 40 is located on a retractable pillar 60 and the retractable pillar 60 is located on the centre of the bottom surface 12 of the cleaning tank 10. The height of the pillar 60 is telescopic adjustable. The porous container 40 can be adjusted to a suitable position where the ultrasonic waves concentrate.

The control device 20 is an ultrasonic generator. The control device 20 is located outside of the cleaning tank 10. The control device 20 is electrically connected with the ultrasonic transducers 30 via wires 300, and is used to control the ultrasonic transducers 30 to transmit an ultrasonic wave.

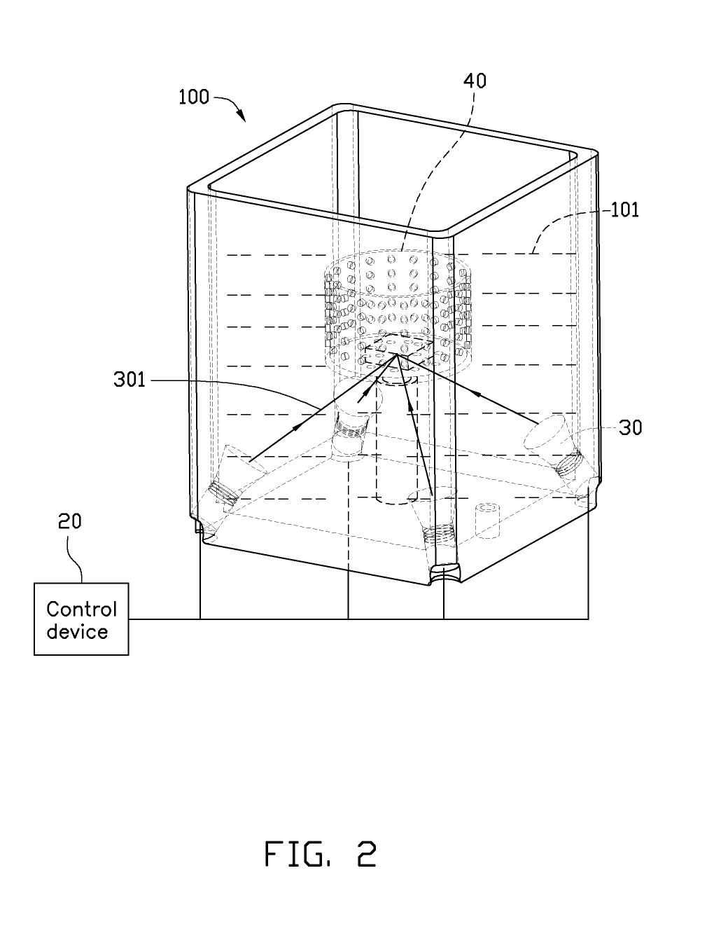

FIG. 2 shows that when the ultrasonic cleaning device 100 is working, the workpieces are received in the container 40. The cleaning tank 10 contains cleaning fluid 101 and the porous container 40 is immersed in the cleaning fluid 101. The ultrasonic cleaning device 100 is powered on, and the control device 20 thereby controls the four ultrasonic transducers 30 to emit high-frequency ultrasonic waves simultaneously. The high-frequency ultrasonic waves arrive to surfaces of the workpieces directly. The high-frequency ultrasonic waves from the ultrasonic transducers 30 concentrate on the surfaces of the workpieces, so it can take away the contamination on the surface effectively.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An ultrasonic cleaning apparatus, comprising:
a cleaning tank comprising a bottom surface;
a number of ultrasonic transducers, the ultrasonic transducers located inside the cleaning tank and inclined in relation to the bottom surface so that ultrasonic waves emitted from the ultrasonic transducers concentrate in a same area within the cleaning tank; and
a control device configured for controlling the ultrasonic transducers to emit the ultrasonic waves, the control device located outside of the cleaning tank and electrically connected with the ultrasonic transducers.

2. The ultrasonic cleaning apparatus of claim 1, wherein the cleaning apparatus comprises four side surfaces which are all connected to the bottom surface, the four side surfaces are sequentially connected to each other one by one, each two adjacent side surfaces and the bottom surface cooperatively form a corner, each corner is mounted with a respective one of the ultrasonic transducers.

3. The ultrasonic cleaning apparatus of claim 2, wherein the number of the ultrasonic transducers is four, the number of the corners is four, and each of the corners is mounted with a respective one of the ultrasonic transducers.

4. The ultrasonic cleaning apparatus of claim 1, wherein the number of the ultrasonic transducers is two, the two ultrasonic transducers are arranged on one diagonal line of the bottom surface.

5. The ultrasonic cleaning apparatus of claim 1, wherein the cleaning tank comprises a drain valve.

6. The ultrasonic cleaning apparatus of claim 1, wherein the ultrasonic cleaning apparatus comprises a porous container and a retractable pillar, the porous container is configured for holding a workpiece to be cleaned, and the retractable pillar supports the porous container.

7. The ultrasonic cleaning apparatus of claim 6, wherein the retractable pillar is located on a center of the bottom surface.

8. The ultrasonic cleaning apparatus of claim 6, wherein a height of the retractable pillar is telescopic.

9. The ultrasonic cleaning apparatus of claim 1, wherein the control device is an ultrasonic generator.
